(19) United States
(12) Patent Application Publication
(10) Pub. No.: US 2022/0214443 A1
(43) Pub. Date: Jul. 7, 2022

(54) METHOD FOR SIMULTANEOUS LOCALIZATION AND MAPPING AND MOBILE PLATFORM USING THE SAME

(71) Applicant: ALi Corporation, Hsinchu (TW)

(72) Inventors: Chun-Hsiang SU, Hsinchu (TW); Chia-Jui KUO, Hsinchu (TW); Shui-Shih CHEN, Hsinchu (TW)

(73) Assignee: ALi Corporation, Hsinchu (TW)

(21) Appl. No.: 17/551,148

(22) Filed: Dec. 14, 2021

Related U.S. Application Data
(60) Provisional application No. 63/134,566, filed on Jan. 6, 2021.

(30) Foreign Application Priority Data
Oct. 21, 2021 (CN) 202111224843.6

(51) Int. Cl. G01S 13/86; G01C 22/00

(52) U.S. Cl. CPC G01S 13/86; G01C 22/00

(57) ABSTRACT

Disclosed are a method for simultaneous localization and mapping and a mobile platform using the same. The method for simultaneous localization and mapping is applied to the mobile platform, and includes: continuously collecting and storing odometer data and environment sensing data of the mobile platform when the mobile platform moves based on a motion trajectory; combining a certain amount of the odometer data and the environmental sensing data to obtain environmental information whenever the certain amount of odometer data and environmental sensing data is reached and stored; performing a simultaneous localization and mapping procedure according to a current map and the odometer data and environmental information continuously obtained; repeating the above steps until the mobile platform completes the motion according to the motion trajectory. Therefore, the mobile platform can synthesize the environmental information similar to sensing data of the lidar while moving without installing a high-cost lidar.

### CROSS REFERENCE TO RELATED APPLICATION

This application claims the priority benefit of provisional application Ser. No. 63/134,566, filed on Jan. 6, 2021, and Chinese Patent Application Serial Number 202111224843.6, filed on Oct. 21, 2021, both of which are hereby incorporated by reference in their entireties.

### BACKGROUND

### Technical Field

The present disclosure relates to the technical field of mobile platforms, and in particular to a method for simultaneous localization and mapping and a mobile platform using the same.

### Related Art

At present, the mobile platform usually uses the simultaneous localization and mapping (SLAM) technology to generate environmental maps and perform autonomous positioning.

The SLAM architecture based on a lidar is relatively well-developed, and it is widely used in mobile platform applications such as automated guided vehicles (AGV), autonomous mobile robots (AMR), autonomous vehicles, service robots, and sweeping robots. However, since the SLAM architecture based on the lidar needs to be equipped with the lidar with a complicated structure and a high cost, the mobile platform using this architecture has the problem of the high product cost. In addition, since the operating principle of the lidar is driven by a motor, the lidar is susceptible to vibration, which can cause abnormal operation, and the movable mechanical component employed to scan a light beam in the lidar is prone to wear and tear, which results in the problems of the low product durability and the high damage rate.

### SUMMARY

The present disclosure provides a method for simultaneous localization and mapping and a mobile platform using the same, which can effectively solve the problems of the high product cost, low durability and high damage rate due to the need to set up the lidar on the mobile platform in the application of existing SLAM technology.

In order to solve the above technical problems, the present disclosure is implemented as follows.

According to a first aspect, the present disclosure provides a method for simultaneous localization and mapping, which comprises the following steps of: continuously collecting and storing odometer data and environment sensing data of a mobile platform when the mobile platform moves based on a motion trajectory; combining a certain amount of the odometer data and the environmental sensing data to obtain environmental information whenever the certain amount of odometer data and environmental sensing data is reached and stored; performing a simultaneous localization and mapping procedure according to a current map and the odometer data and environmental information continuously obtained; and repeating the above steps until the mobile platform completes the motion according to the motion trajectory.

According to a second aspect, the present application provides a mobile platform, which comprises: an odometer, an environment sensor, a memory and a processor. The memory is connected to the odometer and the environment sensor, and the processor is connected to the odometer, the environment sensor and the memory. The odometer is configured to continuously collect odometer data of the mobile platform when the mobile platform moves based on a motion trajectory. The environment sensor is configured to continuously collect environmental sensing data of the mobile platform when the mobile platform moves based on the motion trajectory. The memory is configured to continuously store the odometer data and the environmental sensing data of the mobile platform. The processor is configured to combine a certain amount of the odometer data and the environmental sensing data to obtain environmental information whenever the certain amount of the odometer data and the environmental sensing data is reached and stored in the memory; perform a simultaneous localization and mapping procedure according to a current map and the odometer data and the environmental information continuously obtained; and repeat the above steps until the mobile platform completes the motion according to the motion trajectory.

In the embodiments of the present disclosure, when the mobile platform uses the method for simultaneous localization and mapping, it can continuously collect the odometer data and the environment sensing data while moving, so as to synthesize the environmental information, which is similar to the surrounding environment information obtained by 360-degree scanning conducted by the lidar. The obtained environmental information can be used to perform the simultaneous localization and mapping procedure, and then the pose and map of the mobile platform can be updated. Therefore, the mobile platform can obtain the environmental information that is sufficient for stable simultaneous localization and mapping calculations by using a relatively small amount of the environmental sensing data and the odometer data without setting up a high-cost lidar, thereby achieving the technical effects of accurate positioning, reducing the product cost and improving the product durability.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a block diagram of a mobile platform according to an embodiment of the present disclosure.

FIG. 2 is a schematic diagram of a configuration of environmental sensors of a mobile platform according to an embodiment of the present disclosure.

FIG. 3 is a schematic diagram of sensing directions of the environment sensors of the mobile platform of FIG. 2 at time points T1 to T4 when moving.

FIG. 4 is a schematic diagram of a moving direction of the mobile platform of FIG. 2 at time points T1 to T4 when moving.

FIG. 5 is a schematic diagram of relative coordinate points accumulated in the relative coordinate system during the movement of the mobile platform of FIG. 2 from time points T1 to T4 during the movement.

FIG. 6 is a block diagram of a mobile platform according to another embodiment of the present disclosure.

FIG. 7 is a method flowchart of a method for simultaneous localization and mapping according to an embodiment of the present disclosure.

FIG. 8 is a flowchart of an embodiment of the simultaneous localization and mapping procedure described in step 230 in FIG. 7.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

It must be understood that when a component is described as being “connected” or “coupled” to (or with) another component, it may be directly connected or coupled to other components or through an intermediate component. In contrast, when a component is described as being “directly connected” or “directly coupled” to (or with) another component, there are no intermediate components. In addition, unless specifically stated in the specification, any term in the singular case also comprises the meaning of the plural case.

In the following embodiment, the same reference numerals are used to refer to the same or similar elements throughout the disclosure.

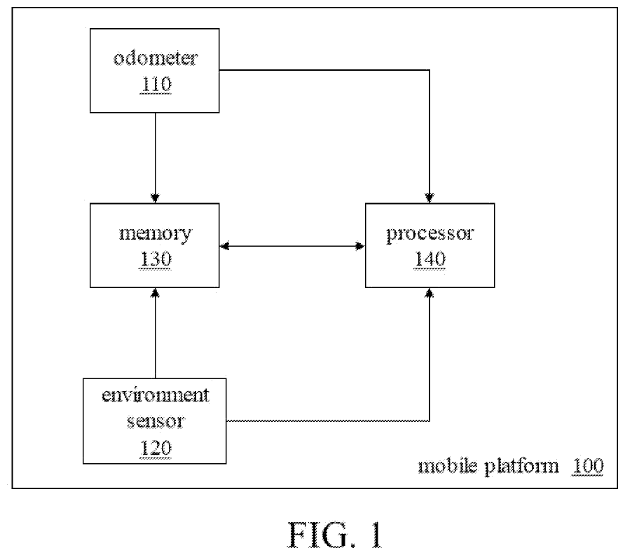

Please refer to FIG. 1, which is a block diagram of a mobile platform according to an embodiment of the present disclosure. As shown in FIG. 1, the mobile platform 100 comprises an odometer 110, an environment sensor 120, a memory 130, and a processor 140. The memory 130 is connected to the odometer 110 and the environment sensor 120, and the processor 140 is connected to the odometer 110, the environment sensor 120 and the memory 130. In this embodiment, there may be but not limited to one environmental sensor 120 and one processor 140, the memory 130 and the odometer 110 may be connected in a wired manner, the memory 130 and the environmental sensor 120 may be connected in a wired manner, the processor 140 and the odometer 110 may be connected in a wired manner, the processor 140 and the environment sensor 120 may be connected in a wired manner, and the processor 140 and the memory 130 may be connected in a wired manner, but this embodiment is not intended to limit the present disclosure.

For example, there are a plurality of environmental sensors 120 and a plurality of processors 140. In one example, there are three environmental sensors 120, and the optical axes of each two of the three environmental sensor 120 form a predetermined angle (that is, the three environmental sensor 120 can be set on the mobile platform 100 and to face in different directions), so that the fields of view of two adjacent environmental sensors 120 can overlap (the angle between the optical axes of two adjacent environmental sensors 120 can be determined by, for example, a predetermined percentage of overlap and the predetermined field of view); the memory 130 and the odometer 110 may be wirelessly connected, the memory 130 and the environmental sensor 120 may be wirelessly connected, the processor 140 and the odometer 110 may be wirelessly connected, the processor 140 and the environment sensor 120 may be wirelessly connected, and the processor 140 and the memory 130 may be wirelessly connected.

In actual implementation, the odometer 110 may be an inertial measurement unit (IMU) or a wheeled odometer; the environmental sensor 120 may be a sensor that uses the time-of-flight principle to measure distance, such as a laser distance sensor, an infrared distance sensor, a ultrasonic sensor or a RGBD camera; the memory 130 includes a high-speed random access memory, and may further include a non-volatile memory, such as at least one magnetic disk storage device, flash memory device, or other non-volatile solid-state storage device; the processor 140 can be a reduced instruction set computer (RISC), a microcontroller unit (MCU), a general-purpose processor, a digital signal processor (DSP), an application specific integrated circuit (ASIC), a field programmable gate array (FPGA) or other programmable logic devices, discrete gates or transistor logic devices, discrete hardware components.

In this embodiment, the odometer 110 is configured to continuously collect odometer data of the mobile platform 100 when the mobile platform 100 moves based on a motion trajectory; the environment sensor 120 is configured to continuously collect environment sensing data used to calculate sensing distances and sensing directions of the mobile platform 100 when the mobile platform 100 moves based on the motion trajectory (that is, information about the distances between the mobile platform 100 and the measured objects in the surrounding environment, such as walls, and obstacles); and the memory 130 is configured to continuously store the odometer data and the environmental sensing data of the mobile platform 100. The processor 140 is configured to combine a certain amount of the odometer data and the environmental sensing data (e.g., 150 pieces of the odometer data and 150 pieces of the environmental sensing data) to obtain environmental information whenever the certain amount of the odometer data and the environmental sensing data is reached and stored in the memory 130, perform a simultaneous localization and mapping procedure according to a current map and the odometer data and the environmental information continuously obtained; and repeats the above steps until the mobile platform 100 completes the motion according to the motion trajectory. The motion trajectory is not limited to any form of movement, and the current map can be stored in the memory 130 or an internal memory of the processor 140.

In an embodiment, the processor 140 is further configured to convert and combine each piece of environmental sensing data accumulated to obtain the environmental information based on the odometer data currently captured at the merger time and each piece of the odometer data accumulated whenever the certain amount of the odometer data and the environmental sensing data is reached and stored. The environmental information is, for example, the distance measured along each angle (or each direction) with the mobile platform 100 as a center. Therefore, the environmental information is equivalent to information about the surrounding environment of the mobile platform 100. In other words, the environmental information is substantially the same as the information obtained by the mobile platform 100 scanning the surrounding environment with itself as the center. The sensing direction of the environmental sensing data collected by the environmental sensor 120 may be related to the position where the environmental sensor 120 is installed on the mobile platform 100. In this embodiment, if the center of the mobile platform 100 is used as a reference point, and the advancing direction of the mobile platform 100 is set to 0 degrees as the angle reference, the sensing direction of the environmental sensing data collected by the environmental sensor 120 (e.g., the direction of the optical axis of the environmental sensor 120) can also be represented by an angle.

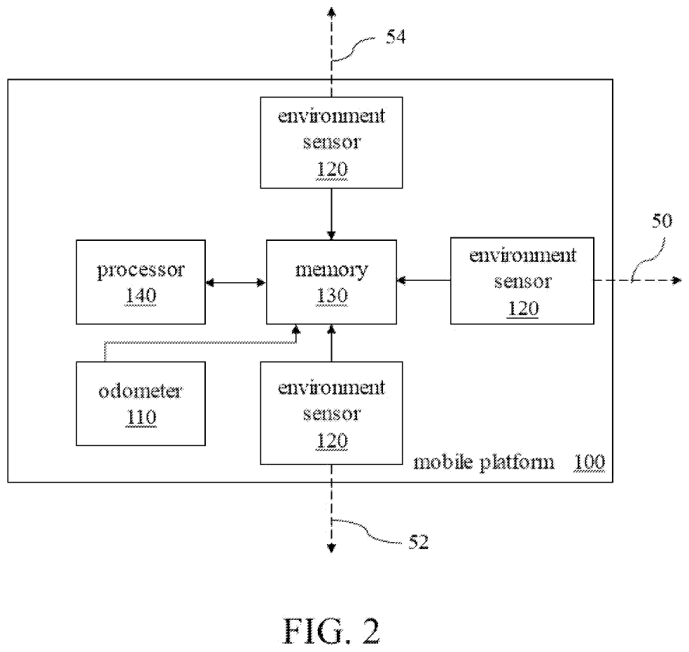

For example, please refer to FIG. 2, which is a schematic diagram of a configuration of environmental sensors of a mobile platform according to an embodiment of the present disclosure. As shown in FIG. 2, when there are three environment sensors 120, the sensing directions of the three environment sensors 120 can be 0 degrees (that is, the optical axis of the environment sensor 120 points to the advancing direction of the mobile platform 100 as shown by the dotted arrow 50 in FIG. 2), 90 degrees (that is, the optical axis of the environmental sensor 120 points to the right side of the mobile platform 100 as shown by the dotted arrow 52 in FIG. 2), and −90 degrees (that is, the optical axis of the environment sensor 120 points to the left side of the mobile platform 100 as shown by the dotted arrow 54 in FIG. 2) respectively.

In addition, each piece of the odometer data can be represented by (X, Y, Θ), wherein X and Y are used to indicate the positions of the mobile platform 100 in the two-dimensional plane in a relative coordinate system, X represents the position of a horizontal axis in the relative coordinate system, Y represents the position of a vertical axis in the relative coordinate system, Θ represents a yaw angle of the mobile platform 100 (that is, the direction on the two-dimensional plane formed by the X axis and the Y axis), and the relative coordinate system can refer to the coordinate system with the mobile platform 100 as the origin of the coordinate system. Therefore, the processor 140 can capture the odometer data obtained by the mobile platform 100 at each data collection point and the sensing direction of each of the three environmental sensors 120 to obtain the distance measured by each of the three environmental sensors 120 at each data collection point. These distances can be further converted into relative coordinate points between each environmental sensor 120 and the environment sensed by it in the relative coordinate system, and when enough data is accumulated, the processor 140 can use the current odometer data and the accumulated odometer data together to convert and merge these relative coordinate points to obtain the environmental information, which represents the information of the surrounding environment of the mobile platform 100, thereby simulating the environmental distance information captured by 360-degree scanning conducted by the lidar or the laser. In this way, it is possible to ensure the stable execution of the simultaneous localization and mapping procedure.

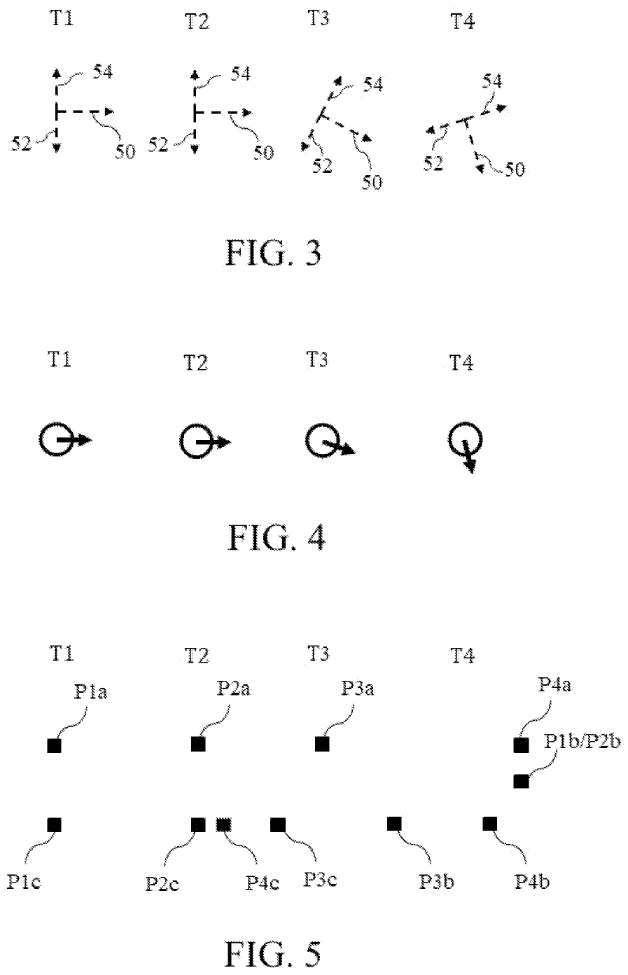

In more detail, please refer to FIG. 3 to FIG. 5, wherein FIG. 3 is a schematic diagram of sensing directions of the environment sensors of the mobile platform of FIG. 2 at time points T1 to T4 when moving, FIG. 4 is a schematic diagram of a moving direction of the mobile platform of FIG. 2 at time points T1 to T4 when moving, and FIG. 5 is a schematic diagram of relative coordinate points accumulated in the relative coordinate system during the movement of the mobile platform of FIG. 2 from time points T1 to T4 during the movement. The setting positions of the three environmental sensors 120 on the mobile platform 100 are fixed, the positions of the mobile platform 100 at time points T1 to T4 are shown by the circles in FIG. 4, and the moving directions of the mobile platform 100 at time points T1 to T4 are shown by the arrow in FIG. 4. When the mobile platform 100 moves at time points T1 to T4, the sensing directions of the three environmental sensors 120 change accordingly as shown in FIG. 3 and FIG. 4. The processor 140 may capture the distance sensed by each environmental sensor 120 of the mobile platform 100 at time points T1 to T4 based on the sensing directions of the three environmental sensors 120 at time points T1 to T4 and the odometer data captured by the odometer 110 at time points T1 to T4, wherein the odometer data may include data related to the moving direction of the mobile platform 100 and data related to location of the mobile platform 100.

The relative coordinate system can be used to describe the distance (that is, the relative coordinate points in the relative coordinate system can be used to present the distance) to obtain the relative coordinate points accumulated during the movement of the mobile platform 100 from time points T1 to T4 as shown in FIG. 5, wherein P1a, P1b, and P1c are the relative coordinate points in the relative coordinate system sensed by the three environmental sensors 120 at the time point T1; P2a, P2b, and P2c are the relative coordinate points in the relative coordinate system sensed by the three environmental sensors 120 at the time point T2; P3a, P3b, and P3c are the relative coordinate points in the relative coordinate system sensed by the three environmental sensors 120 at the time point T3; and P4a, P4b and P4c are the relative coordinate points in the relative coordinate system sensed by the three environmental sensors 120 at the time point T4. It should be noted that, since the moving directions of the mobile platform 100 at the time points T1 and T2 both travels forward, the relative coordinate points P1b and P2b overlap.

When a certain amount of the odometer data and the environmental sensing data is reached and stored from time points T1 to T4, the processor 140 can then perform conversion on the accumulated relative coordinate points from time points T1 to T4 based on the odometer data captured at the merger time point T4 to obtain the environmental information of the mobile platform 100 at time T4, so as to simulate the environmental information that can be sensed by the 360-degree lidar or laser scanning at the time point T4. In a similar fashion, when a certain amount of odometer data and environmental sensing data is reached and stored from time points T5 to T8, the processor 140 can perform conversion on the accumulated relative coordinate points from time points T5 to T8 based on the odometer data captured at the merger time point T8 to obtain the environmental information of the mobile platform 100 at time T8. Finally, the processor 140 can integrate the environmental information obtained by the mobile platform 100 during the movement, and thereby obtain a map of the environment where the mobile platform 100 moves.

In an embodiment, the simultaneous localization and mapping procedure comprises: updating an amount of movement of the mobile platform 100 based on the odometer data and the current map, which are currently collected; and correcting a pose of the mobile platform 100 according to the environment information and the amount of movement of the mobile platform 100, which is updated, and updating the current map. The processor 140 can correct the pose of the mobile platform 100 by a simultaneous localization and mapping algorithm according to the environmental information and the updated amount of movement of the mobile platform 100 and update the current map.

In an embodiment, the processor 140 is further configured to obtain an initial map as the current map and an initial pose of the mobile platform 100 according to the environmental information obtained at a first time. That is, the initial map and the initial pose of the mobile platform 100 can be constructed or initialized according to the environmental information obtained at the first time.

In an embodiment, the processor 140 is configured to combine the certain amount of the odometer data and the environmental sensing data accumulated and stored in the memory 130 to obtain the environmental information and is further configured to combine the odometer data and the environment sensing data accumulated and stored within a default time to obtain the environment information whenever the default time elapses. The default time may be, but is not limited to, 300 milliseconds, but this embodiment is not used to limit the application, and can be adjusted according to actual needs.

In an embodiment, the processor 140 is configured to combine the certain amount of the odometer data and the environmental sensing data accumulated and stored in the memory 130 into the environmental information, and in a process of the mobile platform 100 moving based on the motion trajectory, the processor 140 is further configured to combine the odometer data and the environment sensing data accumulated and stored during the period from when a field of view (FOV) of the environmental sensor 120 of the mobile platform 100 changes to when the field of view has changed to exceed a default angle to obtain the environment information when determining that the field of view has changed to exceed the default angle based on a pose of the mobile platform 100 and the odometer data continuously obtained. The default angle may be, but not limited to, 90 degrees, but this embodiment is not used to limit the present disclosure, and can be adjusted according to actual needs.

In an example, when there is one environmental sensor 120, the default angle may be but not limited to 90 degrees. In another example, when there are three environmental sensors 120, and the placement angle data of the three environmental sensors 120 installed on the mobile platform 100 may comprise 90 degrees, 0 degrees (that is, the advancing direction of the mobile platform 100), and −90 degrees, which represents the directions of the optical axes of the three environmental sensors 120 respectively, the default angle may be, but not limited to, 30 degrees.

It can be seen from the above-mentioned embodiments that the processor 140 may combine the odometer data and the environmental sensing data accumulated to obtain the environmental information whenever the certain amount of the odometer data and the environmental sensing data is reached and stored in the memory 130, the default time elapses, or it is determined that the field of view of the environmental sensor 120 of the mobile platform 100 has changed to exceed the default angle.

However, in other embodiments, the processor 140 may combine the odometer data and the environment sensing data accumulated and stored to obtain the environment information whenever the certain amount of the odometer data and the environment sensing data is reached and stored in the memory 130 and it is determined that the field of view of the environmental sensor 120 of the mobile platform 100 has changed to exceed the default angle. In other embodiments, the processor 140 may combine the odometer data and the environment sensing data accumulated and stored to obtain the environment information whenever the certain amount of the odometer data and the environment sensing data is reached and stored in the memory 130 and the default time elapses. In other embodiments, the processor 140 may combine the odometer data and the environment sensing data accumulated and stored to obtain the environment information whenever it is determined that the field of view of the environmental sensor 120 of the mobile platform 100 has changed to exceed the default angle and the default time elapses. In other embodiments, the processor 140 may combine the odometer data and the environment sensing data accumulated and stored to obtain the environment information whenever the certain amount of the odometer data and the environment sensing data is reached, the default time elapses, and it is determined that the field of view of the environmental sensor 120 of the mobile platform 100 has changed to exceed the default angle.

Therefore, in the present disclosure, the processor 140 can be combine the accumulated odometer data and the accumulated environmental sensing data to obtain the environmental information based on the amount of data accumulated and stored (i.e., the amount of the odometer data and the environmental sensing data accumulated and stored), the time of data collection (i.e., the default time), the change in field of view (i.e., the field of view of the environmental sensor 120 has changed to exceed the default angle), or a combination thereof.

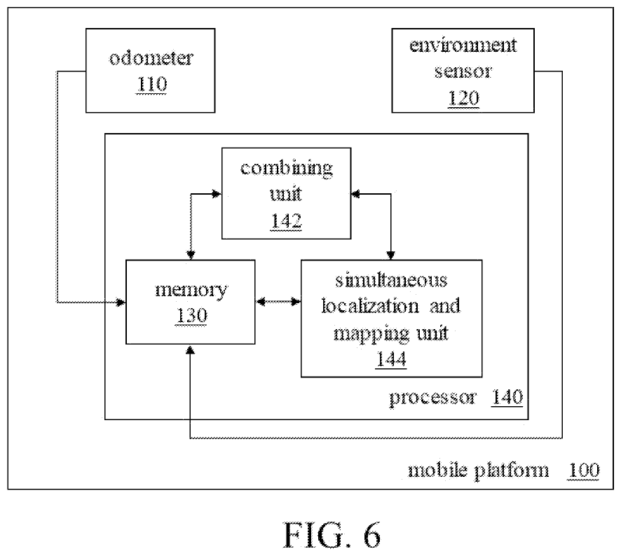

In an embodiment, the odometer data continuously collected by the odometer 110 and the environmental sensing data continuously collected by the environmental sensor 120 are stored in the memory 130 through the processor 140 as shown in FIG. 6, which is a block diagram of a mobile platform according to another embodiment of the present disclosure. In another embodiment, the odometer data continuously collected by the odometer 110 and the environment sensing data continuously collected by the environment sensor 120 are directly stored in the memory 130 as shown in FIG. 1.

In an embodiment, the memory 130 is an internal memory of the processor 140 as shown in FIG. 6.

In an embodiment, the processor 140 may comprise a combining unit 142 and a simultaneous localization and mapping unit 144, and the combining unit 142 is connected to the simultaneous localization and mapping unit 144 (as shown in FIG. 6). The memory 130 may store program code, and the processor 140 executes the program code to generate the combining unit 142 and the simultaneous localization and mapping unit 144, wherein the combining unit 142 is configured to combine the certain amount of the odometer data and the environmental sensing data to obtain the environment information whenever the certain amount of the odometer data and the environmental sensing data is reached and stored in the memory 130, and the simultaneous localization and mapping unit 144 is configured to perform the simultaneous localization and mapping procedure based on the current map and continuously obtained odometer data and environmental information.

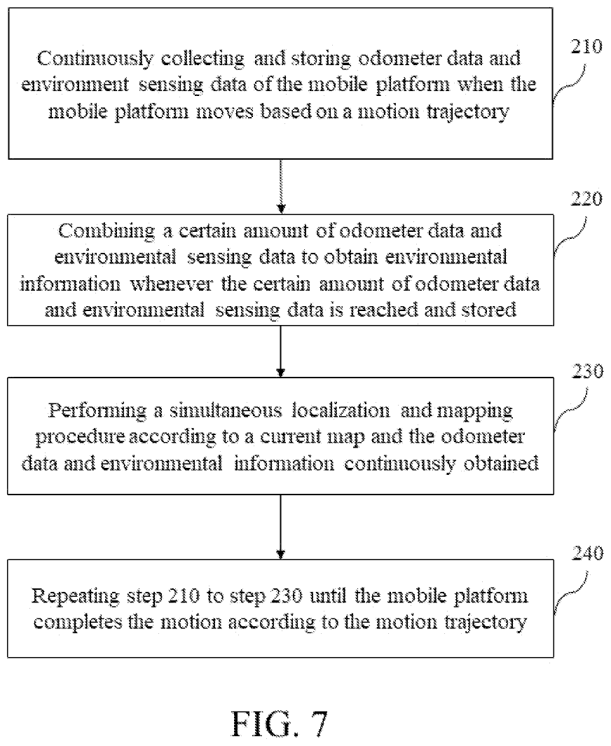

Please refer to FIG. 1 and FIG. 7, wherein FIG. 7 is a method flowchart of a method for simultaneous localization and mapping according to an embodiment of the present disclosure. In this embodiment, the method for simultaneous localization and mapping can be applied to the mobile platform 100, and comprises the following steps of: continuously collecting and storing odometer data and environment sensing data of the mobile platform 100 when the mobile platform 100 moves based on a motion trajectory (step 210); combining a certain amount of odometer data and environmental sensing data to obtain environmental information whenever the certain amount of odometer data and environmental sensing data is reached and stored (step 220); performing a simultaneous localization and mapping procedure according to a current map and the odometer data and environmental information continuously obtained (step 230); and repeating the above steps until the mobile platform 100 completes the motion according to the motion trajectory (step 240). Step 210 is executed by the odometer 110 and the environment sensor 120, and step 220 and step 230 are executed by the memory 130 and the processor 140. For detailed description, please refer to the related description of the mobile platform 100, which will not be repeated here.

In an embodiment, step 220 may comprise: whenever the certain amount of the odometer data and the environmental sensing data is accumulated and stored, converting and combining each piece of the accumulated environmental sensing data to obtain the environmental information based on the odometer data currently captured at the merger time and each piece of the accumulated odometer data, wherein the environmental information is substantially the same as information obtained by the mobile platform scanning surrounding environment with itself as a center. Therefore, the environmental information which simulates the 360-degree scanning results of the lidar or the laser can be obtained. For detailed description, please refer to the related description of the mobile platform 100, which will not be repeated here.

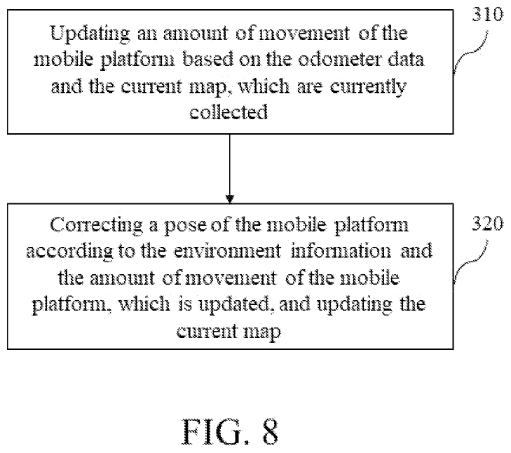

In an embodiment, please refer to FIG. 1, FIG. 7 and FIG. 8, wherein FIG. 8 is a flowchart of an embodiment of the simultaneous localization and mapping procedure described in step 230 in FIG. 7. As shown in FIG. 8, the simultaneous localization and mapping procedure in step 230 comprises: updating an amount of movement of the mobile platform based on the odometer data and the current map, which are currently collected (step 310); and correcting a pose of the mobile platform according to the environment information and the amount of movement of the mobile platform, which is updated, and updating the current map (step 320). Step 320 may comprise: correcting the pose of the mobile platform 100 by a simultaneous localization and mapping algorithm according to the environment information and the amount of movement of the mobile platform 100, which is updated, and updating the current map.

In an embodiment, the method for simultaneous localization and mapping may further comprise: obtaining an initial map as a current map and an initial pose of the mobile platform 100 according to the environment information obtained at a first time. That is, the initial map and the initial pose of the mobile platform 100 can be constructed or initialized according to the environmental information obtained at the first time.

In an embodiment, the method for simultaneous localization and mapping may further comprise: combining the odometer data and the environment sensing data accumulated and stored within a default time to obtain the environment information whenever the default time elapses. For detailed description, please refer to the related description of the mobile platform 100, which will not be repeated here.

In an embodiment, the method for simultaneous localization and mapping may further comprise: in a process of the mobile platform 100 moving based on the motion trajectory, combining the odometer data and the environment sensing data accumulated and stored during the period from a field of view of the environmental sensor 120 of the mobile platform 100 is changed to exceed a default angle to obtain the environment information whenever it is determined that the field of view has changed to exceed the default angle based on a pose of the mobile platform 100 and the odometer data continuously obtained. For detailed description, please refer to the related description of the mobile platform 100, which will not be repeated here.

In an embodiment, the method for simultaneous localization and mapping may further comprise: combining the odometer data and the environment sensing data accumulated and stored to obtain the environment information whenever the certain amount of the odometer data and the environment sensing data is reached and stored in the memory 130 and it is determined that the field of view of the environmental sensor 120 of the mobile platform 100 has changed to exceed the default angle.

In an embodiment, the method for simultaneous localization and mapping may further comprise: combining the odometer data and the environment sensing data accumulated and stored to obtain the environment information whenever the certain amount of the odometer data and the environment sensing data is reached and stored in the memory 130 and the default time elapses.

In an embodiment, the method for simultaneous localization and mapping may further comprise: combining the odometer data and the environment sensing data accumulated and stored to obtain the environment information whenever it is determined that the field of view of the environmental sensor 120 of the mobile platform 100 has changed to exceed the default angle and the default time elapses.

In an embodiment, the method for simultaneous localization and mapping may further comprise: combining the odometer data and the environment sensing data accumulated and stored to obtain the environment information whenever the certain amount of the odometer data and the environment sensing data is reached and stored, the default time elapses, and it is determined that the field of view of the environmental sensor 120 of the mobile platform 100 has changed to exceed the default angle.

In summary, in the embodiments of the present disclosure, when the method for simultaneous localization and mapping is applied to the mobile platform, the mobile platform can perform the simultaneous localization and mapping procedure while moving, so that the continuously collected odometer data and environmental sense are combined to obtain the environmental information similar to the sensing data of the lidar. Therefore, the mobile platform can achieve the technical effects of accurate positioning, lowering the product cost, and improving the product durability without installing the higher-cost lidar.

It is to be understood that the term “comprises”, “comprising”, or any other variants thereof, is intended to encompass a non-exclusive inclusion, such that a process, method, article, or device of a series of elements not only comprise those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A method for simultaneous localization and mapping, applied to a mobile platform, the method for simultaneous localization and mapping comprising the following steps of :
continuously collecting and storing odometer data and environment sensing data of the mobile platform when the mobile platform moves based on a motion trajectory;
combining a certain amount of the odometer data and the environmental sensing data to obtain environmental information whenever the certain amount of odometer data and environmental sensing data is reached and stored;
performing a simultaneous localization and mapping procedure according to a current map and the odometer data and environmental information continuously obtained; and
repeating the above steps until the mobile platform completes the motion according to the motion trajectory.

2. The method according to claim 1, further comprising:
obtaining an initial map as the current map and an initial pose of the mobile platform according to the environment information obtained at a first time.

3. The method according to claim 1, further comprising:
combining the odometer data and the environment sensing data accumulated and stored within a default time to obtain the environment information whenever the default time elapses.

4. The method according to claim 1, further comprising:
in a process of the mobile platform moving based on the motion trajectory, combining the odometer data and the environment sensing data accumulated and stored during the period from a field of view of an environmental sensor of the mobile platform is changed to exceed a default angle to obtain the environment information whenever it is determined that the field of view has changed to exceed the default angle based on a pose of the mobile platform and the odometer data continuously obtained.

5. The method according to claim 1, wherein the simultaneous localization and mapping procedure comprises:
updating an amount of movement of the mobile platform based on the odometer data and the current map, which are currently collected; and
correcting a pose of the mobile platform according to the environment information and the amount of movement of the mobile platform, which is updated, and updating the current map.

6. The method according to claim 5, wherein the step of correcting the pose of the mobile platform according to the environmental information and the amount of movement of the mobile platform, which is updated, and updating the current map comprises:
correcting the pose of the mobile platform by a simultaneous localization and mapping algorithm according to the environment information and the amount of movement of the mobile platform, which is updated, and updating the current map.

7. The method according to claim 1, wherein the mobile platform comprises an environment sensor, the environment sensor is configured to continuously collect the environment sensing data used to calculate sensing distances and sensing directions when the mobile platform moves based on the motion trajectory, and the step of combining the certain amount of the odometer data and the environmental sensing data to obtain the environmental information whenever the certain amount of odometer data and environmental sensing data is reached and stored comprises:
whenever the certain amount of the odometer data and the environmental sensing data is accumulated and stored, converting and combining each piece of the accumulated environmental sensing data to obtain the environmental information based on the odometer data currently captured at the merger time and each piece of the accumulated odometer data, wherein the environmental information is substantially the same as information obtained by the mobile platform scanning surrounding environment with itself as a center.

8. A mobile platform, comprising:
an odometer configured to continuously collect odometer data of the mobile platform when the mobile platform moves based on a motion trajectory;
an environment sensor configured to continuously collect environment sensing data used to calculate sensing distances and sensing directions of the mobile platform when the mobile platform moves based on the motion trajectory;
a memory connected to the odometer and the environment sensor, and configured to continuously store the odometer data and the environment sensing data of the mobile platform; and
a processor connected to the odometer, the environment sensor, and the memory, and configured to combine a certain amount of the odometer data and the environmental sensing data to obtain environmental information whenever the certain amount of odometer data and environmental sensing data is reached and stored in the memory; perform a simultaneous localization and mapping procedure according to a current map and the odometer data and environmental information continuously obtained; and repeat the above steps until the mobile platform completes the motion according to the motion trajectory.

9. The mobile platform according to claim 8, wherein the environmental sensor is a laser distance sensor, an infrared distance sensor, a ultrasonic sensor or a RGBD camera.

10. The mobile platform according to claim 8, wherein the odometer is an inertial measurement unit or a wheel odometer.

11. The mobile platform according to claim 8, wherein the processor is further configured to obtain an initial map as the current map and an initial pose of the mobile platform according to the environmental information obtained at a first time.

12. The mobile platform according to claim 8, wherein the processor is further configured to combine the odometer data and the environment sensing data accumulated and stored within a default time to obtain the environment information whenever the default time elapses.

13. The mobile platform according to claim 8, in a process of the mobile platform moving based on the motion trajectory, the processor is further configured to combine the odometer data and the environment sensing data accumulated and stored during the period from a field of view of the environmental sensor of the mobile platform is changed to exceed a default angle to obtain the environment information when determining that the field of view has changed to exceed the default angle based on a pose of the mobile platform and the odometer data continuously obtained.

14. The mobile platform according to claim 8, wherein the simultaneous localization and mapping procedure comprises:
updating an amount of movement of the mobile platform based on the odometer data and the current map, which are currently collected; and
correcting a pose of the mobile platform according to the environment information and the amount of movement of the mobile platform, which is updated, and updating the current map.

15. The mobile platform according to claim 14, wherein the processor is further configured to correct the pose of the mobile platform by a simultaneous localization and mapping algorithm according to the environment information and the amount of movement of the mobile platform, which is updated, and update the current map.

16. The mobile platform according to claim 8, wherein whenever the certain amount of the odometer data and the environmental sensing data is accumulated and stored, the processor is further configured to convert and combine each piece of the accumulated environmental sensing data to obtain the environmental information based on the odometer data currently captured at the merger time and each piece of the accumulated odometer data, wherein the environmental information is substantially the same as information obtained by the mobile platform scanning surrounding environment with itself as a center.

17. The mobile platform according to claim 8, wherein the odometer data continuously collected by the odometer and the environmental sensing data continuously collected by the environmental sensor are stored in the memory through the processor.

18. The mobile platform according to claim 8, wherein the memory is an internal memory of the processor.
